(19) United States
(12) Patent Application Publication
(10) Pub. No.: US 2019/0030497 A1
(43) Pub. Date: Jan. 31, 2019

(54) METHOD FOR PRODUCING EMULSIONS

(71) Applicant: Instillo GmbH, Ueberherrn (DE)

(72) Inventors: Bernd BAUMSTUEMMLER, Saarlouis (DE); Hermann SCHIRRA, Saarbruecken (DE); Akif Emre TUERELI, Saarlouis (DE)

(73) Assignee: Instillo GmbH, Ueberherrn (DE)

(21) Appl. No.: 16/072,208

(22) PCT Filed: Jan. 25, 2017
(86) PCT No.: PCT/DE2017/100046

§ 371 Date: Jul. 26, 2018

(30) Foreign Application Priority Data
Jan. 25, 2016 (DE) 10 2016 101 232.7

(51) Int. Cl. B01F 3/08; B01F 3/22; B01F 5/02

(52) U.S. Cl. CPC B01F 3/0811; B01F 3/2215; B01F 3/2284; B01F 5/0256; B01F 2215/0481; B01F 2215/0427; B01F 2215/0431; B01F 2215/0468; B01F 2003/0849

(57) ABSTRACT

The invention relates to a method for preparing emulsions.

In order to create a new method for preparing emulsions, in which homogenous oil droplets as small as possible can be generated with an energy input as low as possible, it is proposed in the scope of the invention, that at least two liquid streams of liquids that cannot be intermixed with one another are pumped through separate openings with defined diameters, in order to achieve flow velocity of the liquid streams of more than 10 m/sec., and in that the liquid streams collide at a collision point in a space, wherein the resulting emulsion is discharged from the space through an outlet.

By the collision of the liquid streams with high flow velocities, in which a plate-shaped collision plate is formed in the collision point, a homogenous emulsion having an oil droplet size of less than 1 μm is achieved due to the kinetic energy, which is accordingly very stable as well. No further energy input, such as shear forces, is required to that end.

The invention relates to a method for preparing emulsions.

Hereinafter, the term emulsions refers to colloidal emulsions as well as to technical emulsions, wherein technical emulsions differ from the colloidal emulsions by considerably larger particle dimensions in the micron range.

A plurality of industrial branches, e.g. the food industry, pharmaceutical industry and cosmetics industry, have a high demand for encapsulation, the protecting or targeted release of hydrophobic substances such as bioactive lipids, fragrances, antioxidants and pharmaceuticals.

Emulsions are formed when two or more non-mixable liquids are mixed with one another. As a rule, one of these liquids is water-soluble, and the other one is a lipophilic fluid, which cannot be mixed with water. Depending on the mixing ratios and the surface modifier used, either water-in-oil emulsions or oil-in-water emulsions can be prepared. One disadvantage of emulsions lies with their instability, which is due to physicochemical properties, such as gravity separation, flocculation, coalescence and Ostwald ripening. In oil-in-water-solutions, the most common reason for instability is the gravity separation in the form of “creaming”, which occurs due to the low density of the oil particles.

There are various conventional methods for preparing emulsions. These methods are in particular the mixing with high shearing forces (“high shear mixing”, rotor/stator systems), high pressure homogenization, micro-fluidization, ultrasonic homogenization or membrane emulsification. Most of these methods require high energy input into the system to control the droplet size of the oil droplets formed. Said energy input can occur in different ways, e.g. by heating, shear forces, pressure increase or pressure decrease. The stability of the emulsion increases with decreasing droplet size. Emulsions with an oil droplet size of more than 10 μm tend to transform into two separate phases after a short time, whereas with an oil droplet size of less than 1 μm, the stability of the emulsion increases with decreasing oil droplet size. Nevertheless, an oil droplet size of less than 1 μm requires an energy input four times larger in (order to reduce the oil droplet size by 50%, which limits the achievable minimum oil droplet size. In addition, due to the energy input, there is a risk of a temperature rise to temperatures above 70° C., in which destruction of the emulsifying agents can occur.

In another technique, called membrane emulsification, the limiting factors are the pore size of the membranes used, and the pressure resulting due to the viscosity of the oil phase.

In the micro-fluidization, multiple runs are required even under high-pressure conditions in order to make the oil droplet size less than 1 μm. Due to the fact that the emulsion formation occurs in microchannels, a clogging of these microchannels is one of the most common problems in this method.

DE 10 2009 008 478 A1 describes a method in which a solvent/antisolvent precipitation occurs in the presence of surface-active molecules, wherein a microjet reactor according to EP 1 165 224 B1 is used. Such a microjet reactor comprises at least two opposite nozzles with in each case a pump and a feed line respectively assigned for spraying in each case a liquid medium into a reactor space enclosed by a reactor housing onto a joint collision point, wherein a first opening is provided in the reactor housing, through which opening a gas, a vaporizing liquid, a cooling liquid or a cooling gas can be introduced for maintaining the gas atmosphere in the reactor interior, in particular in the collision point of the liquid jets, or for cooling the resulting products, and another opening is provided for removing the resulting products and the excess gas from the reactor housing. In this way, a gas, a vaporizing liquid or a cooling gas is introduced into the reactor space via an opening, in order to maintain a gas atmosphere in the reactor interior, in particular in the collision point of the liquid jets, or for cooling the resulting products, and the resulting products and the excess gas are removed from the reactor housing by means of overpressure on the gas entry side or by a negative pressure on the product/gas exit side. If a solvent/non-solvent precipitation is carried out in such a microjet reactor, as described in EP 2 550 092 A1 for example, a dispersion of the precipitated particles is obtained. Through the use of such a reactor, particularly small particles can be generated. In this context, a solvent/non-solvent precipitation means that a substance is dissolved in a solvent and collides, in the form of a liquid jet, with a second liquid jet, wherein the dissolved substance is precipitated again. Disadvantageous here is the fact that the dissolved and re-precipitated substance is present in the solvent/non-solvent mixture in the particulate form. Here, the solvent proportion effects that depending on the time, an Ostwald ripening takes place in many particles, which causes growth of the particles.

DE 10 2009 036 537 B3 discloses a device for emulsifying at least two liquids, the device including an emulsifying reactor, having an outlet for removing the emulsion resulting upon mixing the liquids and in which a multitude of nozzles is provided, which are directed for the injection on to substantially one common collision point, wherein each nozzle has a feed line and a pump respectively assigned to it, which respectively pumps a liquid from an assigned tank through the feed line and into the emulsifying reactor.

It is therefore the object of the invention to provide a novel method for preparing emulsions which allows also the preparation of asymmetric emulsions.

According to the invention, this object is achieved in that in a first step, at least a pre-emulsion is prepared from at least two, non-intermixable liquids, and then, in a second step, at least two liquid streams of the at least one pre-emulsion are pumped through separate openings with defined diameters, in order to achieve flow velocity of the liquid streams of more than 10 m/sec. and that the liquid streams collide at a collision point in a space.

Due to the fact that in a plurality of emulsions, i.e. the asymmetric emulsions, in which the oil and water phases are not present in a ratio of 1:1, it turned out to be advantageous in the scope of the invention to first prepare a pre-emulsion from the oil and water phases. This can be effected via conventional stirring processes, ultrasonic treatment, Ultraturrax, a dissolver disc, etc. This pre-emulsion, in the form of two liquid streams, is introduced into a device in which both liquid streams collide at a collision point in a space, e.g. a microjet reactor.

By the collision of the liquid streams with high flow velocities, in which a plate-shaped collision plate is formed in the collision point, a homogenous emulsion having an oil droplet size of less than 1 μm is achieved due to the kinetic energy, which accordingly is very stable as well. No further energy input, such as shear forces, is required to that end. One can operate in aqueous phase with temperatures between 0° C. and 100° C., preferably with temperatures between room temperature and 70° C., particularly preferably with temperatures between room temperature and 50° C. The pressure of the pressure jets ranges between 5 and 5,000 bar, preferably between 10 and 1,000 bar, and particularly preferably between 20 and 500 bar.

Because the collision is effected in the space, there is no risk of clogging, as exists is the case of microchannels. The oil droplet size can be influenced by the diameter of the openings, the flow velocity of the liquid streams and the temperature. The resulting emulsion is discharged from the space through the outlet. Therefore, this is a continuously-operating process. In order to achieve oil droplet sizes as small as possible, it is possible to re-introduce an already-obtained emulsion into the space through both inlets under the same conditions, which can be repeated multiple times, if necessary.

It is also possible to connect the outlet of the space with the gas inlet of a second space, in which further liquid streams are introduced into the formed emulsion, e.g. in order to change the surface characteristics of the emulsion.

If two liquid streams collide, they preferably include an angle of 180°, with three liquid streams, the angle preferably is 120°, etc. In the case of three liquid streams, two liquids cannot be mixed with one another, etc.

According to the invention, it is preferred that the diameter of the openings is the same or different, and is 10 to 5,000 μm, preferably 50 to 3,000 μm, and particularly preferably 100 to 2,000 μm. It is possible to operate with openings of different diameter, e.g. on one side of an opening with a diameter of 100 μM, and on the other side of an opening with a diameter of 300 μm. Of course, the diameters of the openings can be identical on both sides.

According to the invention, it is provided that the flow velocity of the liquid streams downstream the nozzle are identical or different, and are more than 20 m/sec., preferably more than 50 m/sec., and particularly preferably more than 100 m/sec.

Likewise, one of the liquid streams can have a higher flow velocity than the other liquid stream here, e.g. 50 m/sec. on the one side and 100 m/sec. on the other side. It is likewise possible here that the flow velocities of both liquid streams are equal.

The flow velocity of the liquid streams downstream the nozzle can reach 500 m/sec. or even 1,000 msec.

Preferably, the distance between the openings is less than 5 cm, preferably less than 3 cm, and particularly preferably less than 1 cm.

It is also within the scope of the invention that the space is filled or pressurized with gas.

Gas, in particular inert gas or inert gas mixtures, but also reactive gas can be fed into this space through a gas inlet.

It is preferred for the gas pressure in the space to range between 0.05 to 30 bar, preferably 0.2 to 10 bar, and particularly preferably 0.5 to 5 bar.

The droplet size can also be influenced through the gas pressure.

It can be reasonable to heat or cool the gas before it enters the space, in order to influence the temperature inside the space.

It is furthermore in the scope of the invention that a solvent is introduced into the space through another inlet.

For example, propylene glycol as another solvent can be introduced into the space through the further inlet.

One embodiment of the invention consists in that a pressure of less than 100 bar, preferably less than 50 bar, and particularly preferably of less than 20 bar prevails in the space during collision.

It is also possible to guide the liquid streams and/or the resulting emulsion through a heat exchanger, in order to control the temperature of the liquid streams prior to the collision or the temperature of the emulsion after the collision, respectively.

Finally, it is in the scope of the invention to use a microjet reactor for performing the method.

Such a microjet reactor is known from EP 1 165 224 B1.

By means of the method used in the microjet reactor, i.e. the collision of jets under increased pressure, the droplet size of the emulsion depends on the system and operating parameters, in particular the nozzle size in the microjet reactor and the pump pressure of the conveying pumps for the two liquid streams. In the method according to the invention, by contrast with the conventional use of microjet reactors, precipitation reactions do not occur in the microjet reactor due to the collision energy, but instead emulsions are formed.

It is also in the scope of the invention that the prepared emulsion is encapsulated in a further step.

It is also in the scope of the invention that the prepared and possibly encapsulated emulsion is provided with a surface modification in a further step.

Hereinafter, the invention is explained in greater detail by means of exemplary embodiments.

Examples 1 to 4 show the effects of the variation of individual parameters, whereas examples 5 to 21 contain examples for possible encapsulation methods.

### EXAMPLE 1: EFFECTS OF GAS PRESSURE

The effect of the gas pressure was examined in that a liquid stream of oil and a liquid stream of water containing lecithin were made to collide under different gas pressures in a space, into which gas with different gas pressures was introduced through a gas inlet. The oil was pumped with a flow rate of 50 ml/min and the aqueous phase was pumped with a flow rate of 250 ml/min. The oil droplet size was determined by means of DLS. In all cases, an oil droplet size of less than 500 nm was achieved. The results show that the oil droplet size decreases with increasing gas pressure.

| Pressure (bar) | Oil droplet size (nm) |
|---|---|
| 1 | 455 |
| 1.5 | 368 |
| 2 | 294 |
| 2.5 | 274 |
| 3 | 268 |

It can be concluded that the pressure acting on the system via the gas inlet has a direct influence on the oil droplet size.

### EXAMPLE 2: EFFECT OF THE FLOW RATE

The effect of the flow rate was examined in that various flow rates were used for the oil phase and the water phase with a constant ratio of flow rates. For all experiments, a pressure of 2 bar was used in the space.

| Oil flow rate (ml/min) | Water flow rate (ml/min) | Oil droplet size (nm) |
|---|---|---|
| 10 | 50 | 596 |
| 20 | 100 | 427 |
| 30 | 150 | 348 |
| 50 | 250 | 294 |
| 100 | 500 | 257 |

The oil droplet size within the formed emulsion thus decreases with increasing flow rates.

### EXAMPLE 3: DIAMETER OF THE OPENINGS

The influence of the diameter of the openings was determined in that different opening diameters were tested, while an oil flow rate of 50 ml/min and a water flow rate of 250 ml/min were used, and the gas pressure was 2 bar.

| Opening diameter (μm) | Oil droplet size (nm) |
|---|---|
| 200 | 294 |
| 300 | 318 |
| 400 | 567 |
| 500 | 785 |

The smaller the opening diameter, the smaller the oil droplet size within the formed emulsion.

### EXAMPLE 4: NUMBER OF CYCLES

The oil and the water phases were pre-emulsified and pumped through the two inlets into a closed cycle in order to determine the influence of the number of cycles on the oil droplet size within the emulsion. A flow rate of 250 ml/min and a gas pressure of 2 bar prevailed in the space here.

| Number of cycles | Oil droplet size |
|---|---|
| 1 | 650 |
| 2 | 540 |
| 3 | 420 |
| 4 | 355 |

The oil droplet size within the emulsion therefore also decreases with the number of cycles.

### Encapsulation Via a Solvent/Non-Solvent Process: Example 5 to 8

### EXAMPLE 5: COACERVATION

An essential oil to be encapsulated is emulsified, in the microjet reactor, at a flow rate of 67 g/min with an aqueous Na-caseinate solution (22.4 mg/ml) at a flow rate of 200 g/min. In the next step, this emulsion is processed with a flow rate of 200 g/min against an aqueous xanthan solution (0.25%) at 25 g/min. In this step, oppositely-charged side groups of the protein and of the polysaccharide mutually adsorb. Owing to the pH decrease to pH 4 by means of 10-% citric acid, this interaction is intensified, whereby microcapsules result. These microcapsules have a size of 50-100 μm.

### EXAMPLE 6: DRYING

An essential oil to be encapsulated is emulsified in the microjet reactor at a flow rate of 50 g/min into an aqueous whey protein isolate solution with a flow rate of 200 g/min. After adding 20% maltodextrin as a carrier material, the emulsion is spray-dried. A powder containing microencapsulated essential oil develops through the drying process.

### EXAMPLE 7: MELT DISPERSION/MATRIX ENCAPSULATION

A fragrance (15-30%) to be encapsulated is dissolved in melted Compritol AO 888 at 85° C. This oil phase, at 68 ml/min, is emulsified into a 20° C. cold aqueous Tween 20 solution (0.5-1.5%) at 200 ml/min. Due to the rapid cooling of the fat, particle formation occurs directly with emulsion formation, and thus matrix encapsulation of the fragrance. The microcapsules are 5 μm (0.5% Tween 20) or 2 μm (1.5% Tween 20) on average.

### EXAMPLE 8: MELT DISPERSION WITH MODIFIED SURFACE

A fragrance (15-30%) to be encapsulated is dissolved in melted Compritol AO 888 at 85° C. This oil phase, at 68 ml/min, is then emulsified into a 20° C. cold aqueous gum acacia solution (2.5%; 200 ml/min). Due to the rapid cooling of the fat, particle formation occurs directly after the emulsion formation.

A modification of the microcapsules is made in that the melt dispersion (200 ml/min) is processed, in die microjet reactor, against a 50° C. gelatin solution (2.5%; 150 g/min). By decreasing the pH-value to pH 4 through 10% citric acid, the ionic interactions are increased and gelatinized by cooling.

### Relative Encapsulation: Examples 9 to 18

### EXAMPLE 9

A hydrophilic polyalcohol (active substance) to be encapsulated is added (water phase) to an aqueous ammonia solution (1%) and processed, in the MJR reactor, against an emulsifying agent-containing (polyetheralkyl-polymethysiloxane) 1% encapsulation solution (TEOS) in isoparaffin (oil phase). With the solutions (50:50) having the same flow rate, a process pressure of 40 bar is set upstream the nozzles.

A stable emulsion is formed, on the phase interfaces of which the encapsulation material is formed due to hydrolysis of the precursors. The capsules can be separated by simple sedimentation or centrifugation and have a size between 5 and 10 μm.

### EXAMPLES 10 AND 11

The method used in 1 is applied to the encapsulating substances OTMS, PTMS.

At a constant flow rate, the obtained microcapsules have approximately the same characteristics at a reduced reaction time.

### EXAMPLES 12, 13 AND 14

The method stated in 1 is applied to variable flow rates. By variation of the flow rate, ratios of the dispersing phase (active substance) to oil phase of 30:70, 40:60 and 60:40 can be realized.

The size of the obtained microcapsules increases with a growing proportion of the dispersing phase (active substance solution).

### EXAMPLES 15 AND 16

The method stated in 1 is applied to a TEOS-containing encapsulation solution, with the modification that the concentration of the emulsifying agent used was reduced to 50% or 25% of the original concentration. The obtained microcapsules are larger than those achieved according to example 1.

### EXAMPLE 17

The method stated in 1 is applied to another chemical encapsulation composition. A 20% solution of an aqueous substance to be encapsulated, the solution containing 10 meq NH2 of the encapsulating component HDMA, is processed in isoparaffin, in the MJR, against an emulsifying agent solution. The emulsion obtained this way is cured by adding 40 meq COCl a 20% trimesoyl chloride solution in Isopar. The obtained capsules have a size of between 2 and 30 μm.

### EXAMPLE 18

The method stated in example 17 is used, with the modification that curing of the capsules is effected in situ using a trimesoyl chloride solution by continuously introducing the solution into the reactor chamber via the 5^{th} opening of the MJR reactor. The obtained capsules have approximately the same characteristics as were obtained according to example 9.

### Oil-Dissolvable Active Ingredients: Examples 19 to 20

### EXAMPLE 19

The method stated in Example 5 is applied to oil-dissolvable encapsulating substances. An oil-dissolvable active substance to be encapsulated is added into a 20%-solution of the encapsulating material (OTMS) in isoparaffin and mixed by stirring at room temperature for 5 minutes. In the MJR reactor, the solution obtained this way is processed at a process pressure of 40 bar, against an aqueous 2% emulsifying agent solution. A stable, homogenous emulsion results, and curing the capsules occurs by adding the catalyst dibutyltin laureate (0.5%), which capsules can be separated after curing by means of centrifugation or sedimentation.

### EXAMPLE 20

The method stated in example 19 is applied, with the modification that curing of the capsules occurs by means of dibutyltin laureate in situ by continuously introducing the solution into the reactor chamber via the 5^{th} opening of the MJR reactor. The obtained capsules have approximately the same characteristics as were obtained according to example 19.

### Melt Dispersion/Matrix Encapsulation: Example 21

### EXAMPLE 21

Step 1:

Fusing of a polymer (e.g. PEGs, waxes, fats, . . . )

By selecting the substance to be fused, either a hydrophilic or an oleophilic melt can be produced.

Step 2a:

Stirring the solid active substances into the melt (e.g. surfactants, peroxo compounds, enzymes, . . . )

Step 2b (as an Alternative to Step 2a):

Stirring the liquid active substance into the melt

Step 3a:

Transferring the modified melt in the MJR process using a cold non-solvent as a second liquid stream under precipitation of loaded polymeric microbeads.

Step 3b (as an Alternative to Step 3a):

Mixing the modified melt with a hot non-solvent (pre-emulsion). This pre-emulsion is introduced into the MJR on the left and on the right with a flow rate ratio of 1:1. Taking advantage of the cooling effect of the inert carrier gas, the loaded polymer is precipitated in microscale manner.

Step 3c (as an Alternative to Step 3a or Step 3b)

In order to reduce the melt viscosity, the modified melt is mixed with part of the heated non-solvent. The mixture is precipitated then with the cold remaining non-solvent in the MJR-process under precipitation of the polymeric beads.

1-13. (canceled)

14. A method for preparing emulsions, wherein in a first step, at least one pre-emulsion is prepared from at least two non-intermixable liquids, and then in a second step, in a microjet reactor, at least two liquid streams of the at least one pre-emulsion are pumped through separate nozzles with defined diameters, wherein the pressure of the liquid jets is between 5 and 500 bar, in order to achieve flow velocity of the liquid streams of more than 10 m/sec., and wherein the liquid streams collide at a collision point in a space, wherein the space is filled or pressurized with gas and the gas pressure in the space is 0.05 to 30 bar.

15. The method according to claim 14, wherein the diameter of the nozzles is identical or different, and is 10 to 5,000 μm, preferably 50 to 3,000 μm, and particularly preferably to 100 to 2,000 μm.

16. The method according to claim 14, wherein the flow velocity of the liquid streams is identical or different and is more than 20 m/sec., preferably more than 50 m/sec., and particularly preferably to more than 100 m/sec.

17. The method according to claim 14, wherein the distance between the nozzles is less than 5 cm, preferably less than 3 cm and particularly preferably less than 1 cm.

18. The method according to claim 14, wherein the gas pressure in the space is 0.2 to 10 bar and preferably 0.5 to 5 bar.

19. The method according to claim 14, wherein the gas is heated or cooled before entering the space, in order to influence the temperature in the space.

20. The method according to claim 14, wherein a solvent is introduced into the space via another inlet.

21. The method according to claim 14, wherein a pressure of less than 100 bar, preferably less than 50 bar, and particularly preferably less than 20 bar prevails in the space during collision.

22. The method according to claim 14, wherein the liquid streams and/or the resulting emulsion are guided through a heat exchanger, in order to control the temperature of the liquid streams prior to the collision or the temperature of the emulsion after the collision, respectively.

23. The method according to claim 14, wherein the prepared emulsion is encapsulated in a further step.

24. The method according to claim 14, wherein in a further step, the prepared and possibly encapsulated emulsion is provided with a surface modification.
